(19) United States
(12) Patent Application Publication
(10) Pub. No.: US 2025/0306942 A1
(43) Pub. Date: Oct. 2, 2025

(54) RESCHEDULING WORK ONTO PERSISTENT THREADS

(71) Applicant: Advanced Micro Devices, Inc., Santa Clara, CA (US)

(72) Inventors: Joseph L. Greathouse, Austin, TX (US); Sean Keely, Austin, TX (US); Alexandru Voicu, Leicester (GB)

(21) Appl. No.: 18/618,838

(22) Filed: Mar. 27, 2024

(51) Int. Cl. G06F 9/38

(52) U.S. Cl. CPC G06F 9/3851; G06F 9/3887; G06F 9/461; G06F 9/3885

(57) ABSTRACT

An apparatus and method for efficiently processing instructions in hardware parallel execution lanes within a processing circuit. In various implementations, a computing system includes a host processing circuit and a parallel data processing circuit that uses multiple single instruction multiple data (SIMD) circuits, each with multiple parallel lanes of execution. The host processing circuit generates an indication specifying a host trap event has occurred, which includes an asynchronous interruption. The host processing circuit stores the indication and information of a host trap handler in a predetermined memory location specifying subsequent tasks to execute. The parallel data processing circuit accesses this predetermined memory location to check for the indication of a trap event. The instructions of the trap handler directs the parallel data processing circuit to store context state information and initiate processing of other tasks.

### BACKGROUND

### Description of the Relevant Art

The parallelization of tasks is used to increase the throughput of computing systems. To this end, compilers extract parallelized tasks from applications to execute in parallel on the system hardware. To increase parallel execution on the hardware, a parallel data processing circuit includes multiple compute circuits, each with multiple processing circuits. Some processors (e.g., GPUs) use circuits with multiple parallel execution lanes, such as single instruction multiple data (SIMD) micro-architectures. These types of micro-architectures provides higher instruction throughput for parallel data applications than a general-purpose micro-architecture. Tasks that benefit from the SIMD micro-architecture are used in a variety of applications in a variety of fields such as medicine, science, chemistry, engineering, social media, finance, and so on.

When using a processor with a SIMD micro-architecture, it is possible to deadlock a parallel data application utilizing multiple threads, which would be supported by a multi-threaded processing circuit. In addition, the execution of separate branches is serialized. Some threads can also include long latency stalls during execution. This can reduce the amount of memory-level parallelism in the application and reduce performance. While parallel data processing circuits are capable of saving context state at a granularity of an entire compute circuit, this requires significant data storage space and limits performance of the application. This also limits the types of applications that can be written for such processors, because program code such as a kernel with more threads than can concurrently fit on the processor may not be able to guarantee forward progress to all threads. For example, some applications may need independent progress between groups of threads (e.g., wavefronts). An application may perform an all-wavefront barrier that would require all wavefronts in the kernel to reach the barrier before continuing. However, if a user attempts to launch more wavefronts than can simultaneously fit on the processor GPU, this can lead to deadlock.

In view of the above, efficient methods and apparatuses for efficiently processing instructions in hardware parallel execution lanes within a processing circuit are desired.

### BRIEF DESCRIPTION OF THE DRAWINGS

FIG. 1 is a generalized diagram of a computing system that efficiently processes instructions in hardware parallel execution lanes within a processing circuit.

FIG. 2 is a generalized diagram of an apparatus that efficiently processes instructions in hardware parallel execution lanes within a processing circuit.

FIG. 3 is a generalized diagram of a method for efficiently processing instructions in hardware parallel execution lanes within a processing circuit.

FIG. 4 is a generalized diagram of a method for efficiently processing instructions in hardware parallel execution lanes within a processing circuit.

FIG. 5 is a generalized diagram of a method for efficiently processing instructions in hardware parallel execution lanes within a processing circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for enabling context saves and restores on a finer granularity than previously possible are disclosed. In particular, systems and methods for per-wavefront context save and restore are disclosed. In various implementations, a computing system includes a parallel data processing circuit that includes one or more compute circuits, each with one or more single instruction multiple data (SIMD) circuits. Each of the SIMD circuits is configured to execute a wavefront of multiple wavefronts of a workgroup. A command processing circuit issues work at the larger granularity of a workgroup that includes multiple wavefronts. The command processing circuit assigns each workgroup to a corresponding compute circuit. By executing instructions of code different from a currently executing wavefront, a SIMD circuit performs save and restore operations at the granularity of a wavefront of an application allowing the application to avoid deadlock. In various implementations, the code is an interrupt handler, which can also be referred to as a “trap handler.” If the application performs an all-wave barrier that requires each of the wavefronts of multiple wavegroups to reach the barrier before any of the wavefronts progress past the barrier, and some of the wavefronts have not yet been assigned to SIMD circuits, then deadlock can occur for the application. When a corresponding SIMD circuit executes the instructions of the code, or the interrupt handler, deadlock is avoided due to the SIMD circuit having the capability of executing another wavefront without waiting for completion of the currently executing wavefront.

Based on detecting an indication of an interrupt, the command processing circuit assigns instructions of code (interrupt handler or other) different from instructions of the currently executing wavefront to at least a particular SIMD circuit. When this particular SIMD circuit executes the instructions of the code, the SIMD circuit stores context state information of the wavefront to memory such as system memory. When executing the instructions of the code, the SIMD circuit also reads context state information of another wavefront and begins executing this other wavefront. In an implementation, the application has 4,096 threads to execute (or run) on the compute circuits, but the parallel data processing circuit is capable of running 1,024 threads (8 compute circuits×4 SIMD circuits per compute circuit×32 parallel lanes per SIMD circuit is 1,024 threads). When the interrupt occurs, this particular SIMD circuit can return its wavefront to a work queue by storing the corresponding context state information in system memory and load the context state information of a least-recently-run wavefront with 32 threads of the 4,096 threads. Therefore, in addition to avoiding deadlock, forward progress of the total number of tasks of the 4,096 threads can be achieved by performing context saves and restores on a finer granularity of a wavefront than the coarse granularity of a workgroup or an entire kernel (function call).

In various implementations, the computing system also includes a host processing circuit that executes a host operating system and the host processing circuit periodically generates an indication that an interrupt host trap event has occurred. As used herein, an “interrupt” can also be referred to as a “host trap event.” In some implementations, the host processing circuit stores the indication and information of a host trap handler (or code or interrupt handler) in a predetermined memory location specifying subsequent tasks to execute and which threads to process the tasks. In an implementation, the predetermined memory location is a memory mapped input/output (MMIO) storage location, or an MMIO register. The parallel data processing circuit accesses this MMIO storage location to check for the indication of a trap event.

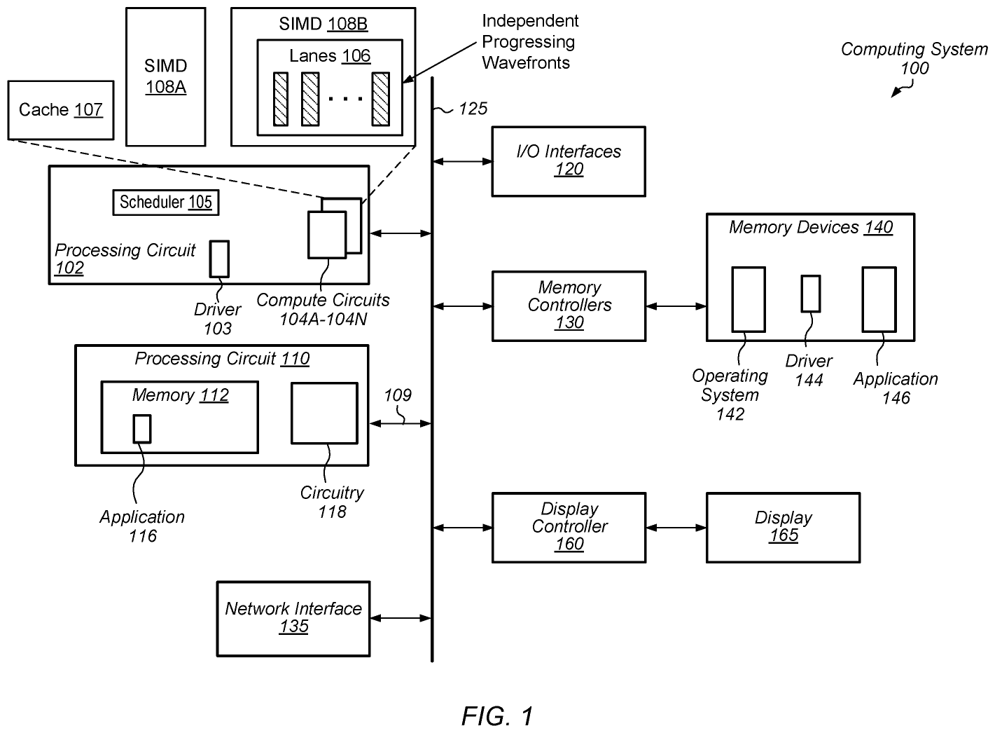

When the parallel data processing circuit has received an indication specifying the interrupt (or host trap event), the parallel data processing circuit accesses the predetermined memory location for trap handler information corresponding to the host trap event. The parallel data processing circuit stores context state information of one or more threads specified by the trap handler information. The parallel data processing circuit stores the context state information to a predetermined memory location, and initiates processing of tasks specified in the trap handler information using its now available multiple parallel lanes of execution. Further details of these techniques for efficiently processing instructions in hardware parallel execution lanes within a processing circuit are provided in the following description of FIGS. 1-5.

Turning now to FIG. 1, a generalized diagram is shown of a computing system 100 that efficiently processes instructions in hardware parallel execution lanes within a processing circuit. In an implementation, computing system 100 includes at least processing circuits 102 and 110, input/output (I/O) interfaces 120, bus 125, network interface 135, memory controllers 130, memory devices 140, display controller 160, and display 165. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on the same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

Processing circuits 102 and 110 are representative of any number of processing circuits which are included in computing system 100. In an implementation, processing circuit 110 is a general-purpose central processing unit (CPU). In one implementation, processing circuit 102 is a parallel data processing circuit with a highly parallel data microarchitecture, such as a GPU. The processing circuit 102 can be a discrete device, such as a dedicated GPU (dGPU), or the processing circuit 102 can be integrated (an iGPU) in the same package as another processing circuit. Other parallel data processing circuits that can be included in computing system 100 include digital signal processing circuits (DSPs), field programmable gate arrays (FPGAs), application specific integrated circuits (ASICs), and so forth.

In various implementations, the processing circuit 102 includes multiple, replicated compute circuits 104A-104N, each including similar circuitry and components such as a single instruction multiple data (SIMD) circuits 108A-108B, the cache 107, and hardware resources (not shown). The SIMD circuit 108A includes replicated circuitry of the circuitry of the SIMD circuit 108B. Although two SIMD circuits are shown, in other implementations, another number of SIMD circuits is used based on design requirements. As shown, the SIMD circuit 108B includes multiple, parallel computational lanes 106. Cache 107 can be used as a shared last-level cache in a compute circuit.

In various implementations, the data flow of SIMD circuit 108B is pipelined and the parallel execution lanes 106 operate in lockstep. In various implementations, the circuitry of each of the execution lanes 106 is an instantiated copy of circuitry for arithmetic logic units (ALUs) that perform integer arithmetic, floating-point arithmetic, Boolean logic operations, branch condition comparisons, and so forth. Each of the ALUs within a given row across the execution lanes 106 includes the same circuitry and functionality, and operates on the same instruction, but different data, such as a different data item, associated with a different thread. Pipeline registers are used for storing intermediate results.

A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.”

Tasks performed by execution lanes 106 can be grouped into a “workgroup” that includes multiple thread groups (or multiple wavefronts). Each of the compute circuits 104A-104N processes an assigned workgroup, and each of the SIMD circuits 108A-108B processes an assigned wavefront. The hardware, such as circuitry, of a scheduler 105 divides the workgroup into separate thread groups (or separate wavefronts) and assigns the wavefronts to be dispatched to SIMD circuits 108A-108B. In an implementation, scheduler 105 is a command processing circuit of a GPU. In some implementations, each of the application 104 stored on the memory devices 140 and its copy (application 116) stored on the memory 112 is a highly parallel data application. The highly parallel data application includes function calls that allow the developer to insert requests in the highly parallel data application for launching wavefronts of a kernel (function call). In various implementations, circuitry 118 of the processing circuit 110 converts (translates) the instructions of the highly parallel data application to commands. In various implementations, the processing circuit 110 stores the commands in a ring buffer in system memory provided by memory devices 140. Processing circuit 102 reads the commands from the ring buffer in the system memory provided by memory devices 140. In an implementation, the ring buffer includes multiple storage locations of the memory devices 140 used to provide a memory mapped input/output (MMIO) first-in-first-out (FIFO) buffer.

In some implementations, application 104 is a highly parallel data application that provides multiple kernels to be executed on the compute circuits 104A-104N. The high parallelism offered by the hardware of the compute circuits 104A-104N is used for real-time data processing. Examples of real-time data processing are rendering multiple pixels, image blending, pixel shading, vertex shading, and geometry shading. In such cases, each of the data items of a wavefront is a pixel of an image. The compute circuits 104A-104N can also be used to execute other threads that require operating simultaneously with a relatively high number of different data elements (or data items). Examples of these threads are threads for scientific, medical, finance and encryption/decryption computations.

Memory 112 represents a local hierarchical cache memory subsystem. Memory 112 stores source data, intermediate results data, results data, and copies of data and instructions stored in memory devices 140. Processing circuit 110 is coupled to bus 125 via interface 106. Processing circuit 110 receives, via interface 106, copies of various data and instructions, such as the operating system 142, one or more device drivers such as device driver 144, one or more applications such as application 104, and/or other data and instructions. The processing circuit 110 retrieves a copy of the application 104 from the memory devices 140, and the processing circuit 110 stores this copy as application 116 in memory 112.

In various implementations, the driver 144 is a driver package that includes separate components. The separate components include at least two driver files, an installation file, a catalog file, and device files. The two driver files of the driver package include dynamic link libraries (DLL) files of a user mode driver (UMD) and a kernel mode driver (KMD). The installation file (.inf file) includes information such as a name of the driver package, a version of the graphics driver package, and registry information. The catalog file includes cryptographic hash values of one or more files in the driver package. These hash values are used by the operating system to verify that the driver package was not altered after the driver package was published (created). The device files include one or more of a device installation application, a device icon, and device properties.

When executed by the circuitry of the processor 110, the operating system authenticates the driver package. After successful authentication, the operating system stores the components of the driver package in a protected system folder. In an implementation, the operating system is a version of the Microsoft® Windows® operating system, and the protected system folder in such a system is called the “Driver Store.” The process of copying the driver package to the protected system folder after authentication is called “staging.” In some implementations, the processing circuit 110 stores a copy of one or more user mode drivers of previously staged driver packages in protected holding locations in the memory devices 140. Driver 103 stored in a local memory of processing circuit 102 is a copy of driver 144.

In various implementations, the processing circuit 110 generates an indication specifying a host trap event, responsive to generating an indication specifying a host trap event has occurred. In some implementations, processing circuit 110 maintains one or more timers used to generate host trap events. If any one of the timers indicates its corresponding threshold period of time has elapsed, then processing circuit 110 generates an indication specifying the host trap event has occurred. In some implementations, the threshold periods of time are programmable and are stored in programmable configuration registers. If processing circuit 110 receives a network packet to be processed by multiple, parallel lanes of execution, then processing circuit 110 generates an indication specifying the host trap event has occurred. If processing circuit 110 detects a variety of other types of asynchronous interrupts, then processing circuit 110 generates an indication specifying the host trap event has occurred. In some implementations, processing circuit 110 stores the indication and information of a host trap handler in a predetermined memory location specifying subsequent tasks to execute and which threads to process the tasks. In an implementation, the predetermined memory location is a memory mapped input/output (MMIO) storage location, or an MMIO register. Processing circuit 102 accesses this MMIO storage location to check for the indication of a trap event.

When processing circuit 102 has received an indication specifying a host trap event, processing circuit 102 accesses the predetermined memory location for trap handler information corresponding to the host trap event. Processing circuit 102 stores context state information of one or more threads specified by the trap handler information. Processing circuit 102 stores the stores context state information to one or more of cache 107, another level of the cache memory subsystem, and memory devices 140. Processing circuit 102 initiates processing of tasks specified in the trap handler information using its now available lanes 106. In an implementation, SIMD circuit 108A continues executing its originally assigned wavefront, whereas SIMD circuit 108B saves context state information of its originally assigned wavefront to memory devices 140, SIMD circuit 108B loads context state information of another wavefront, and SIMD circuit 108B begins execution of the other wavefront using its now available lanes 106.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 150. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 104. In some implementations, application 104 is a highly parallel data application such as a video graphics application, a shader application, or other. Copies of these instructions can be stored in a memory or cache device local to processing circuit 110 and/or processing circuit 102.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network.

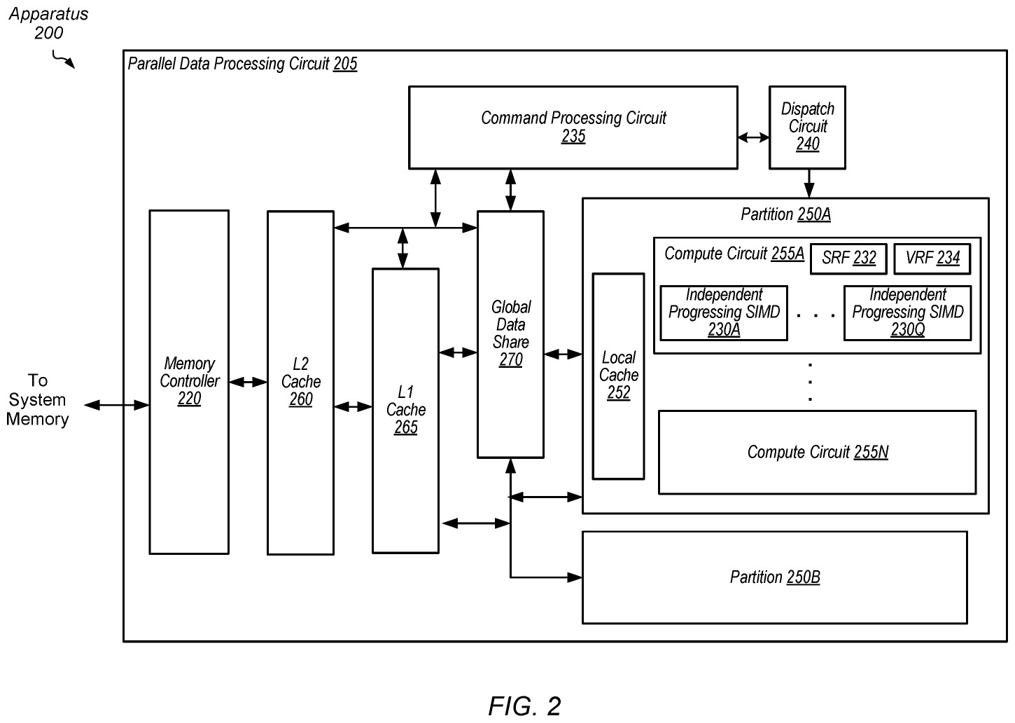

Turning now to FIG. 2, a block diagram is shown of an apparatus 200 that efficiently processes instructions in hardware parallel execution lanes within a processing circuit. In one implementation, apparatus 200 includes the parallel data processing circuit 205 with an interface to system memory. In an implementation, the parallel data processing circuit 205 is a graphics processing unit (GPU). In various implementations, apparatus 200 executes any of various types of highly parallel data applications. As part of executing an application, a host general-purpose processing circuit, such as a central processing unit (CPU) (not shown), assigns kernels to be executed by parallel data processing circuit 205. The command processing circuit 235 receives kernels from the host CPU and determines when dispatch circuit 240 dispatches wavefronts of these kernels to the compute circuits 255A-255N.

Multiple processes of a highly parallel data application provide multiple kernels to be executed on the compute circuits 255A-255N. Each kernel corresponds to a function call of the highly parallel data application. The parallel data processing circuit 205 includes at least the command processing circuit (or command processor) 235, dispatch circuit 240, compute circuits 255A-255N, memory controller 220, global data share 270, shared level one (L1) cache 265, and level two (L2) cache 260. It should be understood that the components and connections shown for the parallel data processing circuit 205 are merely representative of one type processing circuit and does not preclude the use of other types of processing circuits for implementing the techniques presented herein. The apparatus 200 also includes other components which are not shown to avoid obscuring the figure. In other implementations, the parallel data processing circuit 205 includes other components, omits one or more of the illustrated components, has multiple instances of a component even if only one instance is shown in the apparatus 200, and/or is organized in other suitable manners. Also, each connection shown in apparatus 200 is representative of any number of connections between components. Additionally, other connections can exist between components even if these connections are not explicitly shown in apparatus 200.

In an implementation, the memory controller 220 directly communicates with each of the partitions 250A-250B and includes circuitry for supporting communication protocols and queues for storing requests and responses. Threads within wavefronts executing on compute circuits 255A-255N read data from and write data to the cache 252, vector general-purpose registers in vector register file (VRF) 234, scalar general-purpose registers scalar register file (SRF) 232, and when present, the global data share 270, the shared L1 cache 265, and the L2 cache 260. When present, it is noted that L1 cache 265 can include separate structures for data and instruction caches. It is also noted that global data share 270, shared L1 cache 265, L2 cache 260, memory controller 220, system memory, and cache 252 can collectively be referred to herein as a “cache memory subsystem”.

In various implementations, the circuitry of partition 250B is a replicated instantiation of the circuitry of partition 250A. In some implementations, each of the partitions 250A-250B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as system on a chip (SoC). A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

One of command processing circuit 235 and control circuitry within the compute circuit 255A determines an assigned number of vector general-purpose registers (VGPRs) per thread, an assigned number of scalar general-purpose registers (SGPRs) per wavefront, and an assigned data storage space of a local data store per workgroup. In an implementation, the local cache 252 represents a last level shared cache structure such as a local level-two (L2) cache within partition 250A. Additionally, each of the multiple compute circuits 255A-255N includes independent progressing SIMD circuits 230A-230Q (or SIMD circuits 230A-230Q), each with circuitry of multiple parallel computational lanes of simultaneous execution. Each of the compute circuits 255A-255N receives a workgroup from the dispatch circuit 240 and stores the multiple wavefronts of the workgroup in a corresponding local dispatch circuit (not shown). A local scheduler within the compute circuits 255A-255N schedules these wavefronts to be dispatched from the local dispatch circuits to the SIMD circuits 230A-230Q. The cache 252 can be a last level shared cache structure of the partition 250A.

In various implementations, each of the SIMD circuits 230A-230Q has the same functionality as SIMD circuits 108A-108B (of FIG. 1). Therefore, each of the SIMD circuits 230A-230Q checks a predetermined data storage location for an indication that a host trap event has occurred. By doing so, SIMD circuits 230A-230Q support independent progression on different wavefronts from originally assigned wavefronts. SIMD circuits 230A-230Q support per-wavefront context save-and-restore operations within a process by using internal hardware that allows the host operating system (or kernel mode driver) to send interrupts to individual wavefronts running on SIMD circuits 230A-230Q. When executing instructions of the host operating system or kernel mode driver, an external processing circuit, such as an external CPU, generates a host trap, which causes threads of a wavefront executing on SIMD 230A to jump to a previously registered trap handler. By jumping to the trap handler, the multiple parallel lanes of SIMD 230A begins executing other code.

This trap handler directs the threads running on the multiple parallel lanes of SIMD circuit 230A to store context state information of currently running tasks to memory, return this task to a work queue, and begin execution of another task from the work queue. By periodically interrupting threads of a wavefront of SIMD 230A (or any other one of SIMD circuits 230A-230Q), apparatus 200 supports interrupt-driven preemptive scheduling and removes limitations of traditional scheduling methods. The new scheduling approach uses one or more of the host operating system of a host processing circuit and a device driver of apparatus 200 to generate the traps, save work (context state information of a current task), and begin execution of new work (tasks). The multiple parallel lanes of SIMD circuit 230A supports sending context state information to a predetermined memory location.

The host operating system or the device driver supports a timer that operates externally from the threads of the wavefront executing on SIMD circuit 230A. The timer is used to periodically halt the execution of a particular thread. This allows a computing system using apparatus 200 to achieve fairness between different wavefronts and prevent the wavefronts from getting stuck due to a lack of progress. Reading out the context state information can be done via the trap handler being executed by the multiple parallel lanes of SIMD circuit 230A or via a debugger bus. The context state information also includes details such as the task running on the corresponding wavefront, and the number of registers required by the task. it requires. Apparatus 200 also supports enabling execution of different types of tasks on SIMD circuits 230A-230Q and dynamically modifying register allocation. This modification becomes necessary when a task requires more registers than the wavefront has available. Modification can include releasing some registers to allocate them elsewhere or attempting to increase the register count, with the hardware indicating whether it is possible or not. In various implementations, processing circuit 102 (of FIG. 1) has the same functionality as apparatus 200.

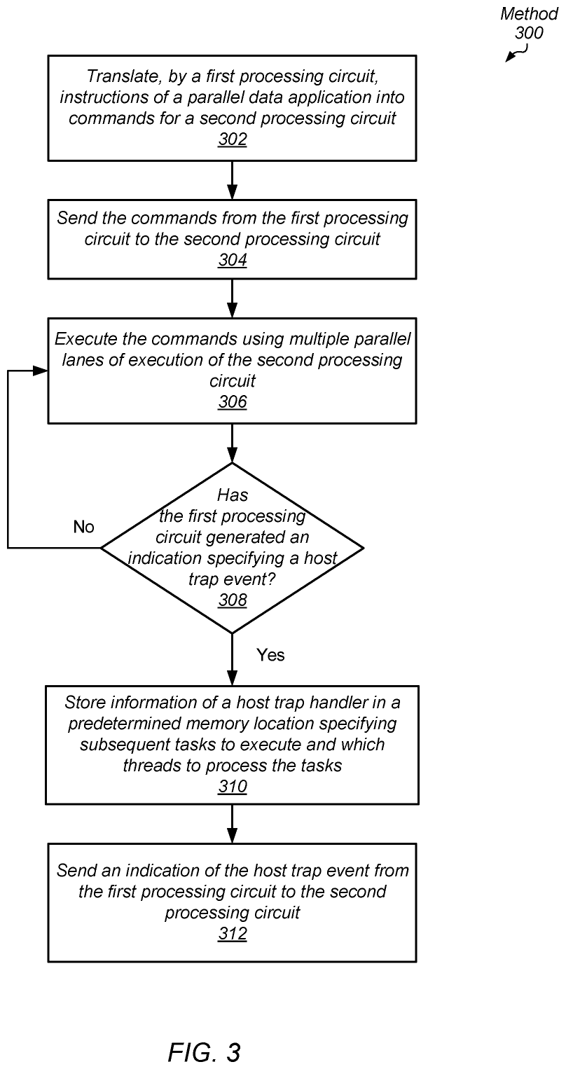

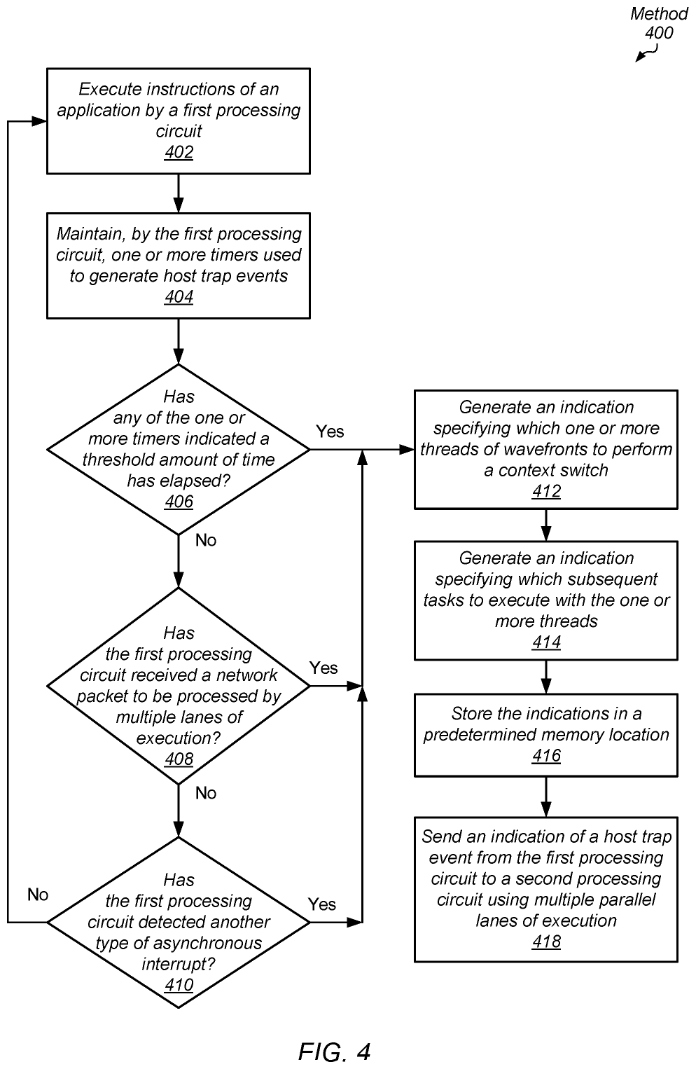

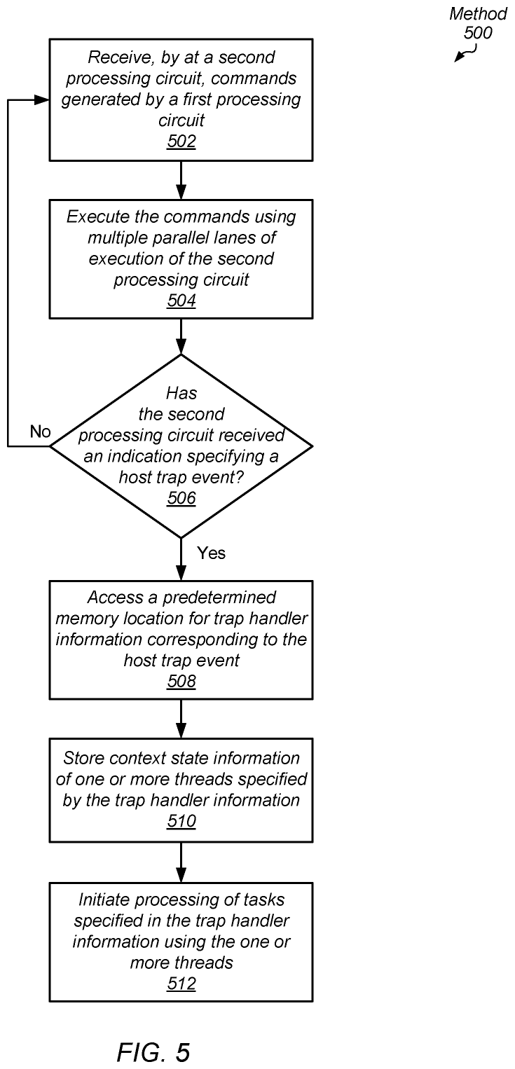

Referring to FIG. 3, a generalized diagram is shown of a method 300 for efficiently processing instructions in hardware parallel execution lanes within a processing circuit. For purposes of discussion, the steps in this implementation (as well as in FIGS. 4-5) are shown in sequential order. However, in other implementations some steps occur in a different order than shown, some steps are performed concurrently, some steps are combined with other steps, and some steps are absent.

A first processing circuit generates commands for a second processing circuit by translating instructions of a parallel data application (block 302). Circuitry sends the commands from the first processing circuit to the second processing circuit (block 304). In various implementations, the first processing circuit stores the commands in a ring buffer in system memory. The second processing circuit reads the commands from the ring buffer in the system memory. The second processing circuit executes the commands using multiple parallel lanes of execution of the second processing circuit (block 306). If the first processing circuit has not yet generated an indication specifying a host trap event (“no” branch of the conditional block 308), then control flow of method 300 returns to block 306 where the second processing circuit executes the commands using multiple parallel lanes of execution of the second processing circuit.

If the first processing circuit has generated an indication specifying a host trap event (“yes” branch of the conditional block 308), then the first processing circuit stores information of a host trap handler in a predetermined memory location specifying subsequent tasks to execute and which threads to process the tasks (block 310). In some implementations, the subsequent tasks are least-recently-run wavefronts of the currently running application. In an implementation, the application has 4,096 threads to execute (or run) on the compute circuits of the second processing circuit, but the second processing circuit is capable of running 1,024 threads (8 compute circuits×4 SIMD circuits per compute circuit×32 parallel lanes per SIMD circuit is 1,024 threads). When the interrupt occurs, this particular SIMD circuit can return its wavefront to a work queue by storing the corresponding context state information in system memory and load the context state information of a least-recently-run wavefront with 32 threads of the 4,096 threads. Therefore, in addition to avoiding deadlock, forward progress of the total number of tasks of the 4,096 threads can be achieved by performing context saves and restores on a finer granularity of a wavefront than the coarse granularity of a workgroup or an entire kernel (function call). The first processing circuit sends an indication of the host trap event from the first processing circuit to the second processing circuit (block 312).

Referring to FIG. 4, a generalized diagram is shown of a method 400 for efficiently processing instructions in hardware parallel execution lanes within a processing circuit. A first processing circuit executes instructions of an application (block 402). The first processing circuit maintains one or more timers used to generate host trap events (block 404). If no time of the one or more timers has indicated a threshold amount of time has elapsed (“no” branch of the conditional block 406), then other checks are performed before generating an indication of a trap event. If the first processing circuit has not received a network packet to be processed by multiple, parallel lanes of execution (“no” branch of the conditional block 408), then other checks are performed before generating an indication of a trap event. If the first processing circuit has not detected another type of asynchronous interrupt (“no” branch of the conditional block 410), and no checks indicated an asynchronous interrupt for a second processing circuit that uses multiple, parallel lanes of execution has occurred, then control flow of method 400 returns to block 402 where the first processing circuit executes instructions of an application.

If the first processing circuit has detected an asynchronous interrupt for the second processing circuit, such as at least the checks performed in conditional blocks 406, 408 and 410, then the first processing circuit generates an indication specifying which one or more threads of wavefronts to perform a context switch (block 412). The first processing circuit generates an indication specifying which subsequent tasks to execute with the one or more threads (block 414). The first processing circuit stores the indications in a predetermined memory location (block 416). The first processing circuit sends an indication of a host trap event from the first processing circuit to a second processing circuit using multiple parallel lanes of execution (block 418).

Referring to FIG. 5, a generalized diagram is shown of a method 500 for efficiently processing instructions in hardware parallel execution lanes within a processing circuit. A second processing circuit that uses multiple, parallel lanes of execution receives commands generated by a first processing circuit (block 502). The second processing circuit executes the commands using the multiple parallel lanes of execution (block 504). If the second processing circuit has not received an indication specifying a host trap event (“no” branch of the conditional block 506), then control flow of method 500 returns to block 502 where second processing circuit that uses multiple, parallel lanes of execution receives commands generated by a first processing circuit.

If the second processing circuit has received an indication specifying a host trap event (“yes” branch of the conditional block 506), then the second processing circuit accesses a predetermined memory location for trap handler information corresponding to the host trap event (block 508). In some implementations, the subsequent tasks are least-recently-run wavefronts of one or more running applications. In an implementation, the second processing circuit is capable of running 1,024 threads (8 compute circuits×4 SIMD circuits per compute circuit×32 parallel lanes per SIMD circuit is 1,024 threads). The second processing circuit is executing 256 threads of a first application that performs video data rendering and the second processing circuit is executing 768 threads of a second application that executes a machine learning data model. When the interrupt occurs, this particular SIMD circuit can return its wavefront to a work queue by storing the corresponding context state information in system memory and load the context state information of a least-recently-run wavefront with 32 threads. Multiple SIMD circuits can change execution from the first application that performs video data rendering to the second application that executes the machine learning data model, or vice-versa.

The second processing circuit stores context state information of one or more threads specified by the trap handler information (block 510). The second processing circuit initiates processing of tasks specified in the trap handler information using the one or more threads (block 512). In another implementation, the second processing circuit executes 1,024 threads with each generating a network packet with long response times. The first processing circuit generates an asynchronous interrupt based on a time period has elapsed, and one or more SIMD circuits perform context saves and restore operations to begin execution of other threads that can now generate and send network packets.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of parallel lanes of execution, each comprising circuitry configured to execute instructions of applications; and
circuitry configured to:
assign a first plurality of instructions of a first application to the plurality of parallel lanes of execution; and
assign a second plurality of instructions of code different from the first application to the plurality of parallel lanes of execution, responsive to receiving an indication of an interrupt; and
wherein responsive to executing the second plurality of instructions of the code, each of one or more of the plurality of parallel lanes of execution is configured to store corresponding first context state to a memory.

2. The apparatus as recited in claim 1, wherein each of the one or more of the plurality of parallel lanes of execution is further configured to read second context state of a third plurality of instructions of the first application different from the first plurality of instructions, wherein the third plurality of instructions are less recently run than the first plurality of instructions.

3. The apparatus as recited in claim 2, wherein to avoid deadlock from occurring for the first application, each of the one or more of the plurality of parallel lanes of execution is further configured to execute the third plurality of instructions using the second context state.

4. The apparatus as recited in claim 3, wherein lanes of the plurality of parallel lanes of execution other than the one or more of the plurality of parallel lanes of execution is further configured to continue executing the first plurality of instructions using the first context state.

5. The apparatus as recited in claim 1, wherein each of one or more of the plurality of parallel lanes of execution is further configured to generate the indication of the interrupt that is an asynchronous interrupt.

6. The apparatus as recited in claim 1, wherein the circuitry is further configured to access a memory mapped input/output (MMIO) storage location in a local memory of the apparatus to check for the indication of the interrupt.

7. The apparatus as recited in claim 1, wherein each of the one or more of the plurality of parallel lanes of execution is further configured to read third context state of a fourth plurality of instructions of a second application different from the first application and the code.

8. A method, comprising:
assigning, by a command processing circuit, a first plurality of instructions of a first application to a plurality of parallel lanes of execution;
responsive to receiving an indication of an interrupt, assigning, by the command processing circuit, a second plurality of instructions of code different from the first application to the plurality of parallel lanes of execution; and
responsive to executing the second plurality of instructions of the code, storing, by each of one or more of the plurality of parallel lanes of execution, corresponding first context state to a memory.

9. The method as recited in claim 8, further comprising reading, by each of the one or more of the plurality of parallel lanes of execution, second context state of a third plurality of instructions of the first application different from the first plurality of instructions, wherein the third plurality of instructions are less recently run than the first plurality of instructions.

10. The method as recited in claim 9, wherein to avoid deadlock from occurring for the first application, the method further comprises executing, by each of the one or more of the plurality of parallel lanes of execution, the third plurality of instructions using the second context state.

11. The method as recited in claim 10, further comprising continuing executing the first plurality of instructions of the first application by lanes of the plurality of parallel lanes of execution other than the one or more of the plurality of parallel lanes of execution.

12. The method as recited in claim 8, further comprising generating the indication of the interrupt that is an asynchronous interrupt by each of one or more of the plurality of parallel lanes of execution.

13. The method as recited in claim 8, further comprising accessing, by the command processing circuit, a memory mapped input/output (MMIO) storage location in a local memory of the command processing circuit to check for the indication of the interrupt.

14. The method as recited in claim 8, further comprising reading, by each of the one or more of the plurality of parallel lanes of execution, third context state of a fourth plurality of instructions of a second application different from the first application and the code.

15. A computing system comprising:
a memory; and
a processing circuit comprising:
a plurality of parallel lanes of execution, each comprising circuitry configured to execute instructions of an application stored in the memory; and
circuitry; and
wherein the circuitry is configured to:
assign a first plurality of instructions of a first application to the plurality of parallel lanes of execution;
assign a second plurality of instructions of code different from the first application to the plurality of parallel lanes of execution, responsive to receiving an indication of an interrupt; and
wherein responsive to executing the instructions of the code, each of one or more of the plurality of parallel lanes of execution is configured to store corresponding first context state to a memory.

16. The computing system as recited in claim 15, wherein each of the one or more of the plurality of parallel lanes of execution is further configured to read second context state of a third plurality of instructions of the first application different from the first plurality of instructions, wherein the third plurality of instructions are less recently run than the first plurality of instructions.

17. The computing system as recited in claim 16, wherein to avoid deadlock from occurring for the first application, each of the one or more of the plurality of parallel lanes of execution is further configured to execute the third plurality of instructions using the second context state.

18. The computing system as recited in claim 17, wherein lanes of the plurality of parallel lanes of execution other than the one or more of the plurality of parallel lanes of execution is further configured to continue executing the first plurality of instructions using the first context state.

19. The computing system as recited in claim 15, wherein each of one or more of the plurality of parallel lanes of execution is further configured to generate the indication of the interrupt that is an asynchronous interrupt.

20. The computing system as recited in claim 15, wherein the circuitry is further configured to access a memory mapped input/output (MMIO) storage location in a local memory to check for the indication of the interrupt.
